(19) United States
(12) Patent Application Publication
(10) Pub. No.: US 2019/0070639 A1
(43) Pub. Date: Mar. 7, 2019

(54) AUTOMATIC CLEANING MACHINE FOR CLEANING PROCESS KITS

(71) Applicant: Applied Materials, Inc., Santa Clara, CA (US)

(72) Inventors: Roy C. NANGOY, Santa Clara, CA (US); Allen L. D'AMBRA, Burlingame, CA (US); Kevin A. PAPKE, Portland, OR (US)

(21) Appl. No.: 15/784,963

(22) Filed: Oct. 16, 2017

Related U.S. Application Data
(60) Provisional application No. 62/555,492, filed on Sep. 7, 2017.

(51) Int. Cl. B08B 3/04

(52) U.S. Cl. CPC B08B 3/04

(57) ABSTRACT

Disclosed herein is an apparatus for cleaning a process kit comprising a body, a cleaning source, and a control system. The body is formed from multiple modules configured to couple to, and receive therein, a process kit part. A plurality of cleaning agents may be sequentially delivered to the body in order to remove the particles disposed on the process part.

### CROSS-REFERENCE TO RELATED APPLICATIONS

This application claims benefit of U.S. provisional patent application Ser. No. 62/555,492, filed Sep. 7, 2017, which is herein incorporated by reference.

### BACKGROUND

### Field

Embodiments of the present disclosure generally relate to an apparatus for cleaning process kits and process kit parts used in semiconductor device and other related electronics manufacturing.

### Description of the Related Art

Semiconductor device and other related electronics manufacturing processes commonly employ the use of process fluid sources to deposit and modify layers on a substrate. Exemplary processes include chemical vapor deposition (CVD) and dry etching. Process fluid is flowed into a processing chamber where it reacts with a substrate or substrate layer to deposit a new film layer, or modify an existing layer, thereon. Portions of the process fluid or byproducts from the process reaction, such as a plasma, also deposit onto surfaces of the components of the process chamber such as a showerhead or shields or liners covering the chamber walls. Over time, the buildup reduces the effectiveness of the reaction, or can begin flaking off, and thereby cause manufacturing defects in the electronic device.

In order to prevent manufacturing defects and maintain the chambers, the deposited buildup should be removed from the surfaces of the processing chamber components. Conventional methods include cleaning the process chamber components with various chemical cleaning agents to remove the deposits. Process chambers are often equipped with removable components such as shields and liners that are commonly replaced with clean versions thereof during opportunities for processing chamber maintenance. Once removed, the dirty components may be cleaned at a locale independent of the chamber body. By replacing the chamber components rather than performing in situ cleaning thereof in the process chamber, the chamber down time required for the maintenance activity is greatly reduced.

Conventional cleaning methods generally involve dipping the components into one or more baths of chemical cleaning agents. The chemical cleaning agent(s) reacts with the deposited material to remove it from the component surface. However, conventional cleaning methods often result in less than adequate removal of the material. Chemical baths generally require components to be dipped in a vertical direction into the cleaning agent bath. As such, different areas of the surface are exposed to the cleaning agents for varying lengths of time. Additionally, complex component features such as trenches or holes cause uneven exposure of the surfaces of the component to the chemical cleaning agents. The uneven exposures result in uneven cleaning across the component cleaned therein.

### SUMMARY

The present disclosure generally relates to a cleaning apparatus for removing particles disposed on a component of a processing chamber, including a body comprised of a first module and a second module, a cleaning agent source, a supply conduit coupled to the body and the cleaning agent source, and a return conduit coupled to the body and a cleaning agent source.

### BRIEF DESCRIPTION OF THE DRAWINGS

So that the manner in which the recited features of the present disclosure can be understood in detail, a more particular description of the disclosure, briefly summarized above, may be had by reference to one or more embodiments, some of which are illustrated in the appended drawings. It is to be noted, however, that the appended drawings illustrate only exemplary embodiments and are therefore not to be considered limiting of its scope, and they may admit to other equally effective embodiments.

FIG. 1 is an exemplary schematic of an automatic cleaning apparatus of an embodiment described herein.

FIG. 2 is a perspective, partial schematic view of an automatic cleaning apparatus.

FIG. 3 is an exemplary schematic of an automatic cleaning apparatus of an embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure is an apparatus for cleaning a process kit comprising a body, a cleaning source, and a control system. The body is formed from multiple modules configured to couple to, and receive therein, a process kit part. A plurality of cleaning agents may be sequentially delivered to the body in order to remove the particles disposed on the process part.

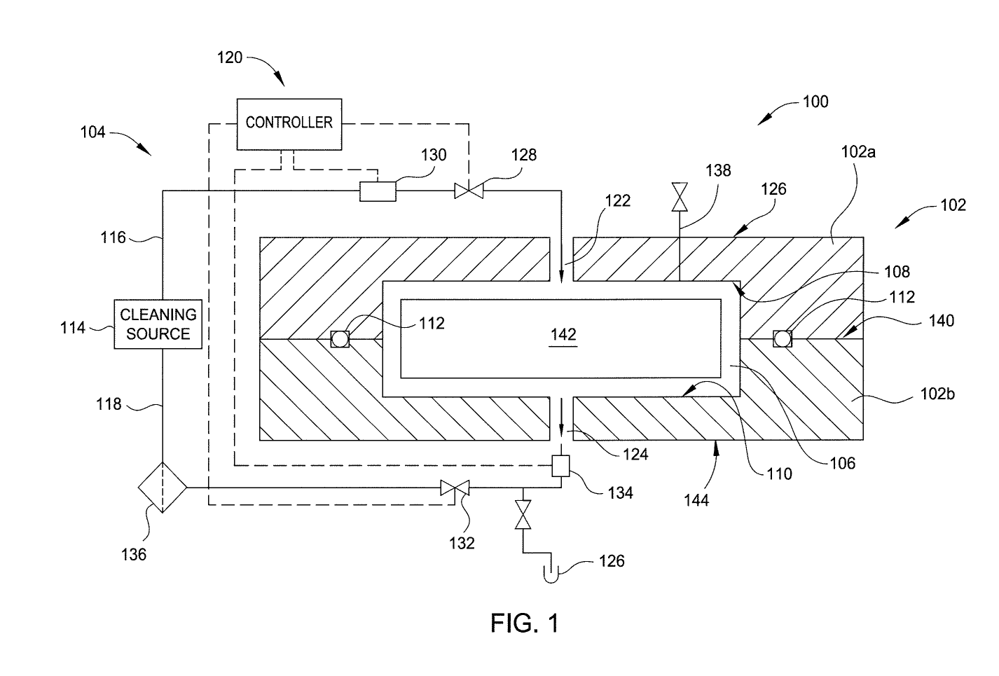

FIG. 1 is a schematic, partial, cross-sectional view of an automated cleaning apparatus according to one embodiment. In the embodiment shown in FIG. 1, an automatic cleaning apparatus 100 comprises a body 102 and a cleaning agent distribution system 104 connected thereto. The body includes an upper module 102a and a lower module 102b. The upper module 102a and the lower module 102b each have an upper surface and a lower surface, wherein the lower surface of the upper module 102a faces the upper surface of the lower module 102b. Recesses 108, 110 are formed on the lower surface of the upper module 102a and the upper surface of the lower module 102b respectively, each forming a depression therein. The upper module 102a and the lower module 102b are configured to mate together the lower surface of the upper module 102a and the upper surface of the lower module 102b at an interface 140. The upper module 102a and the lower module 102b may be adjoined by a connection member (not shown). The connection member may be, for example, bolts, latches, or a hinge, mating flanges held together by a releasable clamp, or other mechanisms, but any connection mechanism suitable for adjoining the modules 102a, 102b and temporarily holding them together at the interface 140 may be utilized. When the upper module 102a and the lower module 102b are adjoined, a process region 106, defined by recesses 108, 110, is formed within the body 102. A part 142 to be cleaned is disposed within the process region 106 before the upper module 102a and the lower module 102b are adjoined. A seal 112 is disposed between the modules 102a, 102b along the interface 140 surfaces circumscribing the processing region 106 to prevent a fluid leak through the interface 140 of the modules 102a, 102b.

The cleaning agent distribution system 104 comprises a cleaning agent source 114, a supply conduit 116, a return conduit 118, and a controller 120. The cleaning agent source 114 contains the fluid cleaning agent. The fluid cleaning agent may be any material suitable for cleaning the part 142 such as a solvent, acid, or water. In some embodiments, the cleaning agent may comprise nitric acid (HNO3), hydrofluoric acid (HF), deionized water, or combinations thereof. The cleaning agent source may be any source suitable for use in the cleaning system such a drum or tank. A pump (not shown) may be coupled to the cleaning agent source and the supply conduit in order to supply the cleaning agent to the process region 106 of the body 102. In certain embodiments, the pump may be a pulsation pneumatic supply pump which supplies the fluid cleaning agent in a pulsated manner to the part 142 wherein the effectiveness of cleaning is increased. The cleaning agent is supplied from the cleaning agent source 114 to the processing region 106 via the supply conduit 116. The supply conduit 116 is coupled to an inlet port 122 formed through the upper module 102a. The inlet port 122 is formed between an outer surface 126 and the recess 108 of the upper module 102a through which the cleaning agent is introduced into the processing region 106. The cleaning agent reacts with deposits on the part 142 disposed within the processing region 106. The cleaning agent may flow around or through the part 142 such that the surfaces of the part are in communication with the cleaning agent. In certain embodiments, the processing region 106 may be completely filled with the cleaning agent wherein the part 142 will be submerged in the cleaning agent. In such cases, a bleed valve 138 is utilized in order to remove air or other gases from the process region 106 in order to completely fill the volume thereof. The cleaning agent flows through an outlet port 124 formed in the lower module 102b between the recess 110 and a lower surface 144. The outlet port 124 is valved and coupled to the return conduit 118. The return conduit 118 is configured to flow the cleaning agent to the cleaning source 114 or to a drain 126. FIG. 1 shows one inlet port 122 and one outlet port 124 but it is contemplated that multiple inlet ports and outlet ports may be utilized.

Valves and instruments may be disposed along the supply conduit 116 and the return conduit 118. In FIG. 1, a first supply valve 128 is disposed between the cleaning source 114 and the inlet port 122. A first instrument 130 is disposed upstream of the supply valve 128. The instrument may be any instrument for measuring parameters of the flow stream such as a flow meter or a sample probe. The supply valve 128 and the first instrument 130 are coupled to a controller 120. An outlet valve 132 and a second instrument 134 are disposed along the return conduit 118 and further coupled to the controller 120. The controller 120 may be configured to receive a signal from the instruments 130, 134 and adjust the valves 128, 132 in order to control the flow of cleaning agent to and from the processing region 106. In certain embodiments, the controller 120 may be configured to adjust valves 128 and 132 without an input from the instruments 130, 134. In further embodiments, multiple controllers may be supplied to control individual valves, individual instrument-valve pairs, or multiple instrument-valve pairs. Any configuration of controllers, instruments, and valves suitable for controlling the flow of liquid in the cleaning process may be utilized. In certain embodiments, a filter 136 is disposed along the return conduit 118. The filter 136 collects particles and other residue materials that are removed from the part 142 as part of the cleaning process and prevents the particles and other residue material from reentering the cleaning agent source 114 or the process region 16.

In FIG. 1, a single cleaning source and associated supply and return conduits are shown. It is contemplated that multiple supply conduits and return conduits may be utilized. It is further contemplated that multiple cleaning agent sources may be utilized. In certain embodiments, more than one cleaning agent source, for example three, containing different cleaning agents may be coupled to multiple supply conduits and multiple return conduits. The multiple supply conduits may be coupled to multiple inlet ports. Similarly, multiple return conduits may be coupled to multiple outlet ports. Any configuration of inlet ports, outlet ports, supply conduits, return conduits and valving suitable for supplying different cleaning agents to the process region, simultaneously or sequentially or separately, with or without individually isolated inlet and outlet paths to the process region 106 of the body, may be used. It is also contemplated that the cleaning agent may be introduced into the process region 106 through an inlet formed in the lower module 102b. It is further contemplated that the cleaning agent may be evacuated through an outlet port formed in the upper module 102a. Still further, it is contemplated that the cleaning agent may be introduced into the processing region 106 and then evacuated from processing region 106 by an inlet port and an outlet port formed within the same module. In certain embodiments, a plurality of inlet ports and outlet ports may be utilized in a patterned arrangement, for example, a grid or a concentric ring pattern. The configuration of the inlet port and outlet port is not limited to embodiments discussed above. Any number, location, and configuration of inlet ports and outlet ports suitable for introducing and evacuating cleaning agent from the process region may be utilized. A pump (not shown) may be disposed in the return conduit 118 to evacuate the cleaning agent from the processing region 106.

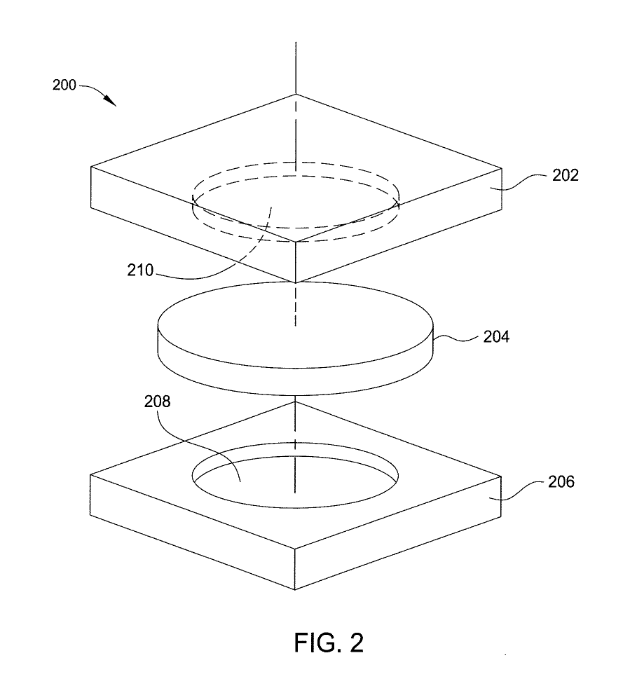

FIG. 2 is schematic, exploded perspective view of a component used in automatic cleaning apparatus according to one embodiment. A cleaning apparatus body 200, like the body 102 of FIG. 1 is shown. The body 200 comprises an upper module 202, like 102a of FIG. 1, and a lower module 206, like 102b of FIG. 1. A part 204 to be cleaned or otherwise fluidly processed is disposed in a recess formed between the upper module 202 and the lower module 206. Circular recesses 210 and 208 are formed in the upper module 202 and the lower module 206, respectively. The recesses 208, 210 do not extend through the entirety of the modules 202, 206. The body 200 has a generally rectangular cross section but other cross sections have been contemplated like circular and ovoid. Similarly, other geometries of recesses 208, 210 have been contemplated such as annular and ovoid. The geometry of the body 200 and the recesses 208,210 are not limited to those shown in FIG. 2. Any shape suitable for holding a part to be cleaned may be utilized.

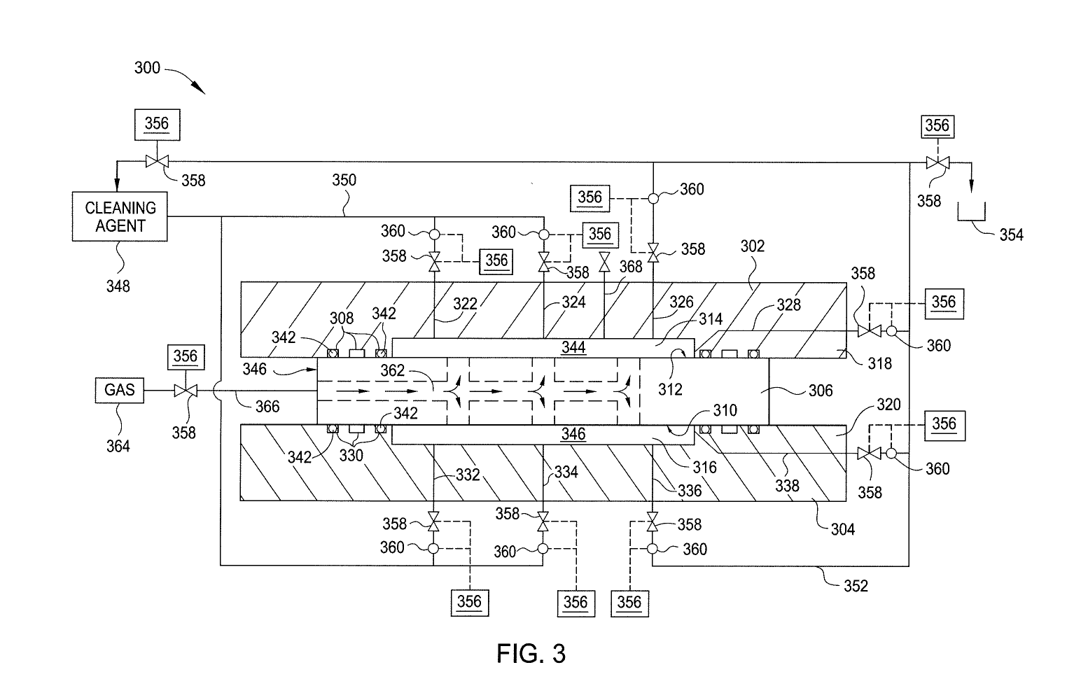

FIG. 3 is a schematic, partial cross-sectional view of an automatic cleaning apparatus 300 according to one embodiment. In FIG. 3, an upper module 302 and a lower module 304 are shown, but unlike the upper module 202 and lower module 206 of FIG. 2, these upper and lower modules 302, 304 are generally plate like and a configured to be secured to opposed sides of a flat planar part to be cleaned, specifically in FIG. 3, a showerhead to be cleaned. A recess 314 is formed in the lower surface of the upper module 302 defined and is surrounded by a circumferential extension 318 of the upper module 302. A first inlet port 322 and a second inlet port 324 are located in the upper module 302 and extend from an upper surface thereof into the recess 314. A first drain 326 is formed within the upper module 302 extending from the upper surface thereof to the recess 314. A second drain 328 formed within the upper module 302 extending through the extension 318 from a sidewall of the upper module 302 to the recess 314. In certain embodiments, the drains 326 and 328 may both extend inwardly to the recess 314 from the upper surface. Circumferential grooves 308 are formed on the circumferential extension 318 of the upper module 302, and extend inwardly thereof spaced apart in a circumference direction of the upper module, where the upper modular is circular. The grooves 308 circumscribe the recess 314. In FIG. 3, three grooves are shown though other numbers, such as 1, 2, or 4, are contemplated.

The lower module 304 contains similar features to the upper module. A recess 316 is formed inwardly of the upper surface of the lower module 304 wherein grooves 330 circumscribe the recess 316. A first inlet port 332, a second inlet port 334, a first drain 336, and a second drain 338 are formed in the lower module 304 extending from an outer surface, such as the lower and side surfaces, thereof to the recess 316. Like drains 326, 328 of the upper module, drains 338 and 338 of the lower module may extend from the same or different outer surfaces of the lower module.

An exemplary part 306 is disposed between the upper module 302 and the lower module 304. The part 306 may be a chamber component to be cleaned such as a showerhead. In the embodiment shown in FIG. 3, the lower surface of the circumferential extension 318 of the upper module 302 and the upper surface of the circumferential extension of the lower module 304 are each located on a surface of the part 306, each on an opposed side of the part. In certain embodiments, the upper module 302 is disposed adjacent an upper surface 312 of the part 306 and the lower module 304 is disposed adjacent a lower surface 310 of the part 306. In FIG. 3, the recesses 314, 316 and grooves 308, 330 face opposed planar surfaces 340 of the part 306. The extensions 318, 320 and seals 342 abut the opposed planar surfaces 340 surfaces of the part 312 and 310, respectively. Seals 342, such as O-rings, are disposed in the grooves 308, 330 and seal against the inner surfaces of the grooves 309, 310 and the adjacent planar surface 340 on the opposed sides of the part 306. Process volumes 344 and 346, defined by the recesses 314, 316 and the respective planar surfaces 340 of the part 306 facing and exposed to the interior of the respective recesses 314, 316. In such embodiments, the seals 342 prevent leaks from the process volumes 344, 346 through the interface area of the extensions 318,310 and the planar surfaces 340. In certain embodiments, seals 342 may comprise an inner seal and an outer seal in different grooves. Here, an inner groove and an outer groove in a circumferential direction of the modules 302, 304. A groove may be disposed between the inner seal and the outer seal creating a leak containment volume. If fluid bypasses the inner seal, it will be contained by the leak containment volume and the outer seal. Additionally, a flow line (not shown) may extend into the leak containment volume to enable a positive pressure to be maintained therein tending to prevent leakage therepast, or to enable a vacuum pressure to be applied to the leak containment volume and remove any cleaning fluid which may have been able to leak past the inner seal 342. Other configurations of seals, such as a single o-ring, have been contemplated but any configuration suitable for containing fluid within the process volume may be utilized. The upper module 302, lower module 304, and part 306 are joined by connection members (not shown) such as bolts, clamps or latches. In certain embodiments, the connection members may be disposed outside a periphery of the part 306. In other embodiments, the connection members may pass through part 306. Any configuration and types of connection members for adjoining the upper module 302, lower module 304, and part 306 may be utilized.

A cleaning agent delivery system comprising a cleaning agent source 348 such as cleaning agent source 114 of FIG. 1, a supply conduit 350, and a return conduit 352 are coupled to the upper module 302 and the lower module 304. A cleaning agent is delivered from the cleaning agent source 348 to the processing volumes 344, 346 by the cleaning agent supply conduit 350. The supply conduit 350 is coupled to the inlet ports 322, 324, 332, 334. That is, the cleaning agent source 348 is in fluid communication with the processing volumes 344, 346 via the supply conduit 350 and the inlet ports 322, 324, 332, 334. A first cleaning agent may be delivered to the processing volumes 344, 346, though the first inlet ports 322, 332. A second cleaning agent may be delivered to the processing volumes 344, 346, though the second inlet ports 324, 334. In certain embodiments, a different cleaning agent may be provided to each of the process volumes 344, 346.

The cleaning agent flows into the processing volumes 344, 346, across the surfaces of part 306, and towards drains 326,328, 336, 338. The drains may be configured to remove the cleaning agent from different locations of the processing volumes 344, 346, including by positive removal therefrom by application of a slight vacuum in the drain(s) 326, 328, 336, 338 and pull the cleaning fluid from the process volume. In FIG. 3, drain 326 is configured to remove the cleaning agent from the upper surface of the processing volume 344 while drain 328 is configured to remove the cleaning agent from a lower location such as the surface of part 306. Similarly, drain 338 is configured to remove the cleaning agent from an upper location of the processing volume 346 and drain 336 removes cleaning agent from a lower location. Drains 326, 328, 336, 338 are coupled to the return conduit 352. Return conduit 352 is configured to deliver the effluent cleaning agent to a return location at the cleaning agent source 348 or an external drain 354. In certain embodiments, a first cleaning agent may be returned to the cleaning agent source 348 and a second cleaning agent may be discarded through the external drain 354 or returned to a different cleaning agent source location.

A fluid control system comprising valves 358, instruments 360, and controllers 356 may be disposed along the supply conduit 350 and return conduit 352. Valves 358 open and close to control or direct flow of the cleaning agents. Instruments 360, such as flow meters or sample probes, measure parameters of the fluid stream such as velocity or concentration. The valves 358 and instruments 360 are coupled to controllers 356. The controllers 356 receive signals from the instruments 360 and provide adjustments to the valves 358. The controllers may be provided to individual valves or connected as a single network controller. In certain embodiments, the fluid control system may comprise controllers 356 and valves 358 without instruments 360 wherein the control system executes a predetermined sequence of adjustments or a program.

In a certain embodiment, the part 306 may contain fluid pathways 362 therethrough for use in delivering gas into a processing chamber, for example configured as a showerhead. Commonly, the fluid pathways 362 have critical dimensions, and the quantity of material buildup in these surfaces which will need to be removed is typically less than that on the planar surfaces 340 of the part, in some cases very nearly no or no built up material. Certain chemistries of cleaning agents erode, corrode or dissolve the surfaces of the pathways 362 when they contact the surface thereof. Thus, the critical dimensions of the pathways may be affected by exposure of the openings to the cleaning fluids for extended periods of time, including any period of time where no build-up of material to be removed is present thereon. To supply the process gas to the pathways, one or more connecting passages will be present, here, a connecting passage 362 extending from an interior portion of the pathways to the sidewall of the part 306. For this reason, the cleaning apparatus 300 may include a gas source 364 in fluid communication with the pathways 362 via a conduit 366 connected to the sidewall opening of the connecting passage 362. A gas, such as air or nitrogen, may be supplied to the processing volumes 344, 346 during a cleaning process. The gas source 364 is configured to supply the gas at a rate and pressure such that the gas exiting the pathways into the process volumes 344, 346 prevents a cleaning agent concurrently supplied to the processing volumes 344, 346 from entering the pathways 362.

In a further embodiment, the process volumes 344, 346 may be liquid filled as part of a cleaning process. A bleed valve 368 may be utilized to remove any gas trapped in the processing volumes 344, 346 to substantially liquid fill the volumes 344, 346.

In each of the above described embodiments, it is contemplated that the modules be located on or in a wet bench having one or more fluid supplies, such as deionized water and cleaning agents in fluid or gas form, at least one drain, and at least one exhaust hood. The inlet and drain conduits of the modules may be directly connected to the fluid supplies and the drain. Additionally, using deionized water, or another non solvent flushing agent, after the cleaning of the part is completed, the surface of the part can be flushed with the flushing agent to remove the cleaning agent before the body is opened and the cleaned part removed, reducing the exposure of adjacent individuals to the cleaning agents.

Additionally, herein a quantity of cleaning agent capable of cleaning the part, which is then recycled, can be introduced into the process volume within which the part is cleaned, or a finite quantity of cleaning agent cycled through the process volume, allowing less cleaning agent to be used, and more particularly, allowing new cleaning agent to be used for each part to be cleaned. In contrast, where parts to be cleaned are lowered into large tanks, the volume of cleaning fluid required to clean the part typically exceeds the volume need to clean the part, and as the chemistry of the cleaning agents used to react with the built up deposits is consumed, the concentration thereof in the tank is reduced, and the time required to clean the next part, and so on, becomes longer. By providing a body with a defined process volume and the ability to expose less fluid to each part being cleaned, the embodiments hereof lead to more predictable cleaning times, leading to less part erosion after the built up material is removed and predictable volumes of cleaning agents required to clean parts. Further, the described embodiments allow the part to be cleaned in a horizontal position to increase the uniformity of the cleanliness of the part surface.

It is understood that the number of cleaning agent sources, supply conduits, inlet ports, return conduits, and drains is not limited. Any number and configuration of cleaning agent delivery system components necessary to perform a cleaning process may be utilized. It is further understood that one of skill in the art may select various cleaning agents and cleaning processes to be practiced with the embodiments described herein.

While the foregoing is directed to embodiments of the present disclosure, other and further embodiments of the disclosure may be devised without departing from the basic scope thereof, and the scope thereof is determined by the claims that follow.

What is claimed is:

1. A system for cleaning a process part, comprising:
a body comprised a first module and a second module;
a cleaning agent source;
a supply conduit coupled to the body and the cleaning agent source; and
a return conduit coupled to the body and a cleaning agent source.

2. The system of claim 1, further comprising a control system, the control system comprising:
a controller;
at least one instrument coupled to the supply conduit or the return conduit; and
at least one valve disposed in the supply conduit or the return conduit;

3. The system of claim 1, wherein the cleaning agent source comprises more than one cleaning agent.

4. The system of claim 1, wherein the body is configured to clean a portion of a part disposed between the first module and the second module.

5. The system of claim 4, further comprising a gas source coupled to the body.

6. The system of claim 2, wherein the control system is configured to selectively deliver a cleaning agent to the body.

7. The system of claim 1, wherein the return conduit is configured to selectively deliver a cleaning agent to the cleaning agent source or to a drain.

8. A system for cleaning a process part, comprising:
a body comprised a first module and a second module;
a cleaning agent source;
a plurality of supply conduits coupled to the body and the cleaning agent source; and
a plurality of return conduits coupled to the body and a cleaning agent source.

9. The system of claim 8, further comprising a control system, the control system comprising:
a controller;
at least one instrument coupled to a supply conduit or return conduit; and
at least one valve disposed in a supply conduit or a return conduit;

10. The system of claim 8, wherein the cleaning agent source comprises more than one cleaning agent source coupled to the plurality of supply conduits.

11. The system of claim 8, wherein the body is configured to clean at least a portion of a part disposed between the first module and the second module.

12. The system of claim 11, further comprising a gas source is coupled to the body.

13. The system of claim 9, wherein the control system is configured to selectively deliver a cleaning agent to the body.

14. The system of claim 8, wherein the return conduit is configured to selectively deliver a cleaning agent to the cleaning agent source or a drain.

15. An apparatus for cleaning a process chamber part, comprising:
a body comprised of a first module and a second module;
a process volume defined by the first module and a second module and a portion of the process chamber part;
a cleaning agent source comprising a plurality of cleaning agents;
a plurality of supply conduits coupled to the body and the cleaning agent source;
a plurality of return conduits coupled to the body and a cleaning agent source; and
a controller coupled to the plurality of supply conduits and return conduits.

16. The apparatus of claim 15, where in the each of the plurality of supply conduits is configured to deliver one of the plurality of cleaning agents.

17. The apparatus of claim 15, wherein the controller is configured to sequentially deliver the plurality of cleaning agents to the process volume.

18. The apparatus of claim 15, further comprising a gas source coupled to the process volume.

19. The apparatus of claim 15, wherein the plurality of return conduits are coupled to a plurality of drain ports disposed within the body.

20. The apparatus of claim 15, further comprising a heater coupled to the cleaning agent source.
